(19) United States
(12) Patent Application Publication
(10) Pub. No.: US 2017/0310217 A1
(43) Pub. Date: Oct. 26, 2017

(54) MULTI-PHASE SWITCHED POWER CONVERTER

(71) Applicant: IDT EUROPE GmbH, Dresden (DE)

(72) Inventor: Chris YOUNG, Round Rock, CA (US)

(21) Appl. No.: 15/517,160

(22) PCT Filed: Sep. 15, 2015
(86) PCT No.: PCT/EP2015/071048

§ 371 Date: Apr. 5, 2017

Related U.S. Application Data
(60) Provisional application No. 62/060,235, filed on Oct. 6, 2014.

(51) Int. Cl. H02M 3/158; H02M 7/49; H02M 5/453; H02M 5/27; H02P 27/16; H02M 1/00

(52) U.S. Cl. CPC H02M 3/158; H02P 27/16; H02M 7/49; H02M 3/1584; H02M 5/453; H02M 5/271; H02M 2001/0032

(57) ABSTRACT

A multi-phase power converter comprising a plurality of phases for generating an output voltage according to a switching signal and an input voltage, each phase of the plurality of phases comprising a switching element and inductance; wherein the plurality of phases is connected to a common star point, wherein an output capacitor is connected to the common star point. The phases of the multi-phase power converter are not identical in terms of their inductance. Therefore, at least one phase may be optimized for a low current such that, in low power operation, said at least one phase is optimal for lower current levels.

### RELATED APPLICATIONS

This application is a 371 national stage application of International Patent Application No. PCT/EP2015/071048 filed Sep. 15, 2015, which claims priority to U.S. Provisional Patent Application No. 62/060,235 filed Oct. 6, 2014, which are incorporated herein by reference in their entirety as part of the present disclosure.

### FIELD OF THE INVENTION

The present disclosure relates to a multi-phase switched power converter.

### BACKGROUND OF THE INVENTION

Contemporary designs of a power converter are chosen to meet specified performance requirements, such as high efficiency, accurate output regulation, fast transient response, low solution cost, etc. A power converter generates an output voltage and current for a load from a given input voltage. It needs to meet the current regulation or load voltage requirement during steady-state and transient conditions. Depending on the specific application, a multi-phase switched power converter may be an appropriate solution.

Generally, a switched power converter works by taking small chunks of energy, bit by bit, from an input voltage source, and moving them to the output. This is accomplished by means of an electrical switch and a controller which controls the rate at which energy is transferred to the output.

Switched power converters comprise a switchable power stage, wherein an output voltage is generated according to a switching signal and an input voltage. The switching signal is generated by a controller that adjusts the output voltage to a reference voltage. The switched power stage comprises a dual switch consisting of a high-side switch and a low-side switch an inductance and a capacitor. During a charge phase, the high-side switch is turned on and the low-side switch is turned off by the switching signal to charge the capacitor. During a discharge phase the high-side switch is turned off and the low-side switch is turned on to match the average inductor current to the load current. The switching signal is generated as digital pulse width modulation signal with a duty cycle determined by a control law.

Switched power converters must operate over a wide range of load conditions. Buck and boost derived converters may have more than one phase for high current applications. A phase comprises a dual switching element and inductor. A plurality of identical phases is connected to a common star point to charge or discharge a common output capacitor.

In many applications, the power converter can operate at a current substantially less than the peak current and even less than the peak current for a single phase. Thus, having identical phases and current capability for each phase may not be optimal.

### BRIEF SUMMARY OF THE INVENTION

A multi-phase power converter, substantially as shown in and/or described in connection with at least one of the figures, as set forth more completely in the claims.

The phases of the multi-phase power converter are not identical in terms of their inductance. Therefore, at least one phase may be optimized for a low current such that, in low power operation, said at least one phase is optimal for lower current levels.

Moreover, the switching elements may be optimized for each phase since an optimal switching device selection depends on the operating current of that phase.

These and other advantages, aspects and novel features of the present disclosure, as well as details of an illustrated embodiment thereof, will be more fully understood from the following description and drawings.

### BRIEF DESCRIPTION OF THE DRAWINGS

Reference will be made to the accompanying drawings, wherein:

FIG. 1 shows a block-diagram of multi-phase power converter.

### DETAILED DESCRIPTION OF THE INVENTION

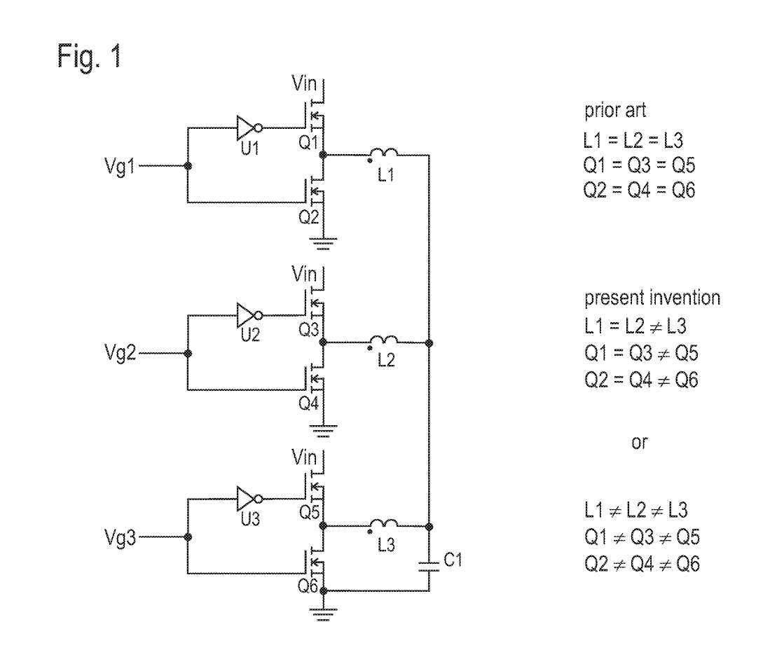

The multi-phase power converter shown in FIG. 1 comprises three phases controlled by switching signals Vg1, Vg2, Vg 3 for generating an output current or voltage according to input voltage Vin and the switching signals.

The first phase comprises a dual switching element comprising an inverter U1 a high-side field effect transistor (FET) Q1 and a low-side FET Q2, and an inductance L1. The second phase comprises a dual switching element comprising an inverter U2 a high-side FET Q3 and a low-side FET Q4, and an inductance L2. The third phase comprises a dual switching element comprising an inverter U3 a high-side FET Q5 and a low-side FET Q6, and an inductance L3.

The three phases are connected to a common star point to which the capacitor C1 is connected to. Each phase produces its own operating current for charging the capacitor C1.

While in the prior art the inductance L1, L2 and L3 are equal and the FETs Q1, Q2, Q3, Q4, Q5 and Q6 are identical, according to the present invention the inductance of at least one phase differs from the inductance of another phase. At least one phase may be optimized for a low current such that, in low power operation, said at least one phase is optimal for lower current levels.

For example, the third phase may be optimized for lower current levels. L1 equals L2, but L3 differs from L1 and L2.

Optimally, the inductance L3 may be selected such that the ripple current is 20%-40% of the peak current value. For fixed input and output voltage, to first order, the ripple current is proportional to the inverse of the inductance.

Moreover, the dual switching elements may be optimized for each phase since an optimal switching device selection depends on the operating current of that phase. Switching elements Q5 and Q6 may be optimized with respect to their size and cost for example, for the operating current of the third phase. Q1 may be identical to Q3, but Q5 may be different from Q1 and Q3. Q2 may be identical to Q4, but Q6 may be different from Q2 and Q4.

The inductance of each of the plurality of phases may be different from the inductance of another phase. Hence, each phase may be optimized for its individual operating current.

Also, the switching element of each of the plurality of phases may be different from the inductance of another phase.

The three-phase buck converter is just an example. The concept of optimized inductances and switching elements for the load conditions of an individual phase may be applied to any buck or boost converter design.

What is claimed is:

1. Multi-phase power converter comprising a plurality of phases for generating an output voltage according to a switching signal and an input voltage, each phase of the plurality of phases comprising a switching element and inductance; wherein the plurality of phases is connected to a common star point, wherein an output capacitor is connected to the common star point; and wherein the inductance of at least one phase differs from the inductance of another phase.

2. The multi-phase power converter according to claim 1, wherein the inductance is anti-proportional to a ripple inductor current.

3. The multi-phase power converter according to claim 2, wherein the inductance of the at least one phase is selected such that the ripple operating current is 20%-40% of a peak current.

4. The multi-phase power converter according to claim 1, wherein the inductance of each of the plurality of phases differs from the inductance of another phase.

5. The multi-phase power converter according to claim 1, wherein the switching element of the at least one phase differs from the switching element of another phase.

6. The multi-phase power converter according to claim 1, wherein the switching element of the at least one phase is optimized for an operating current of said phase.

7. The multi-phase power converter according to claim 5, wherein the switching element is a dual switching element.

8. The multi-phase power converter according to claim 1, wherein the switching element of each of the plurality of phases differs from the inductance of another phase.

9. The multi-phase power converter according to claim 1 being a buck-converter.

10. The multi-phase power converter according to claim 1 being a boost-converter.
